(19) United States
(12) Patent Application Publication
(10) Pub. No.: US 2020/0036527 A1
(43) Pub. Date: Jan. 30, 2020

(54) USER AUTHENTICATION BASED ON PASSWORD-SPECIFIC CRYPTOGRAPHIC KEYS

(71) Applicant: CA, Inc., New York, NY (US)

(72) Inventors: Dhiraj Girdhar, Westborough, MA (US); Dipto Chakravarty, Potomac, MD (US)

(21) Appl. No.: 16/044,222

(22) Filed: Jul. 24, 2018

(51) Int. Cl. H04L 9/32; H04L 29/06; H04L 9/08

(52) U.S. Cl. CPC H04L 9/3228; H04L 63/0838; H04L 9/3242; H04L 9/0863; H04L 9/0869; H04L 9/3271

(57) ABSTRACT

Techniques are disclosed relating to user authentication based on password-specific cryptographic keys. In some embodiments, a user device receives, from an authentication server, an authentication challenge that includes an item of challenge information. Further, in some embodiments, the user device receives user input indicative of a password and then performs a cryptographic function on the password to generate a password-specific cryptographic key. The computing device may access an initial seed value that was previously provided by the authentication server and generate an updated cryptographic key based on the initial seed value and the password-specific key. Further, in various embodiments, the user device generates authentication information based on the updated cryptographic key and the item of challenge information. The user device may then send an authentication response, including the authentication information, to the authentication server. In various embodiments, the password is not included in the authentication response.

### RELATED APPLICATION

The present application is related to U.S. patent application Ser. No. 15/939,075, filed on Mar. 28, 2018.

### BACKGROUND

### Technical Field

This disclosure relates generally to user authentication, and more particularly to user authentication based on password-specific cryptographic keys.

### Description of the Related Art

Server systems, such as web servers, application servers, etc., may provide various computing resources to an end user. For example, an application server may provide access to software applications to various remote users via a network. A server system will typically limit access to its resources to only authorized end users. One method of limiting access is to require end users to provide credentials, such as a username and password, to the server system. The server system then uses the credentials to authenticate the requesting end user prior to providing access to the resource. In some instances, however, such use of credentials may make them vulnerable (e.g., to phishing attacks, interception by a third-party, etc.), presenting security concerns. Thus, in various instances, it may be desirable to implement a user-authentication technique that provides the convenience of a user credential without making that credential vulnerable to unauthorized third parties.

### SUMMARY

Techniques are disclosed relating to user authentication based on password-specific cryptographic keys. For example, a user device may send an access request to access a service provided by a server system. In some embodiments, the user device receives, from an authentication server, an authentication challenge that includes an item of challenge information, where the authentication server is configured to authenticate a user of the user device to the service in response to the access request. Further, in some embodiments, the user device receives user input indicative of a password and then performs a cryptographic function on the password to generate a password-specific cryptographic key. The computing device may access an initial seed value that was previously provided by the authentication server and generate an updated cryptographic key based on the initial seed value and the password-specific cryptographic key. Further, in various embodiments, the user device generates authentication information based on the updated cryptographic key and the item of challenge information. In various embodiments, the user device sends an authentication response, including the authentication information, to the authentication server for a determination of whether to grant the access request. In various embodiments, the password is not included in the authentication response.

### BRIEF DESCRIPTION OF THE DRAWINGS

FIG. 1 is a block diagram illustrating an example system for authenticating an end user to a service, according to some embodiments.

FIG. 2 is a block diagram illustrating an example exchange between a user device and an authentication server to enroll a user in an authentication service, according to some embodiments.

FIG. 3 is a block diagram illustrating an example authentication application, according to some embodiments.

FIG. 4 is a block diagram illustrating an example authentication server, according to some embodiments.

FIG. 5 is a flow diagram illustrating an example method, performed by a user device, for generating authentication information using a password-specific cryptographic key, according to some embodiments.

FIG. 6 is a flow diagram illustrating an example method, performed by an authentication server, for authenticating a user based on authentication information that was generated using a password-specific cryptographic key, according to some embodiments.

FIGS. 7 and 8 are flow diagrams illustrating example methods, respectively performed by a user device and an authentication server, for enrolling a user of the user device in an authentication service provided by the authentication server, according to some embodiments.

FIG. 9 is a block diagram illustrating an example computer system, according to some embodiments.

### DETAILED DESCRIPTION

Server systems implement various authentication techniques in an effort to limit unauthorized access to computing resources. One common authentication technique is to require a requesting user to provide a credential (such as a password, PIN code, etc.) that may be validated against a stored credential for the user. This authentication technique presents various security concerns.

For example, using such an approach, the user must provide the credential to the server (or an authentication server) over a network, which may make the credential susceptible to interception by an unauthorized third party. Further, the server (or authentication server) must store the credential so that it may be used to verify the credential provided by a requesting user, which may also make the credential vulnerable. For example, the server storing the user's credential may be the target of a data breach in which the credentials for some or all authorized users are compromised. In such an instance, having obtained the authorized user's credentials, an unauthorized third party may be able to access the service to the same extent as the authorized user, thus exposing potentially sensitive information and functionality to the unauthorized third party.

The security concerns created by storing user credentials on a server are further exacerbated in instances in which the same credential is used across multiple different services. For example, rather than memorize a different credential (e.g., password) for each different service, it is common for users to establish the same credential across multiple services. In such instances, if the user's credential is compromised on a server for any one of the services, all of the services would be susceptible to unauthorized access by an unauthorized third party. Thus, in various instances, it is desirable to utilize an authentication technique that does not rely on a user credential (e.g., password) being transmitted to, or stored by, a server.

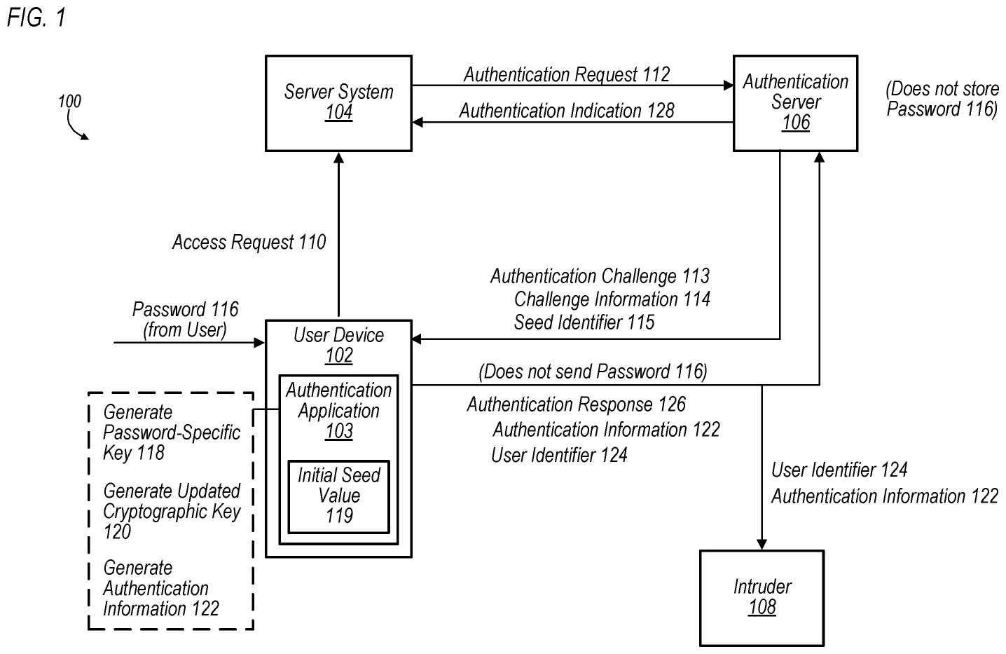

In at least some embodiments, the disclosed systems and methods may mitigate these or other shortcomings by utilizing authentication information generated using password-driven cryptographic keys. Stated differently, disclosed embodiments include generating, at the time of authentication, an updated cryptographic key based on an initial seed value and a password-specific key. That updated cryptographic key may then be used, along with one or more items of challenge information, to generate authentication information that may be used to authenticate the user to the service. In FIG. 1, a block diagram illustrating a system 100 for authenticating an end user to a server system is depicted, according to some embodiments. In the embodiment of FIG. 1, system 100 includes user device 102, server system 104, and authentication server 106. Note that, although shown in direct connection, one or more of user device 102, server system 104, or authentication server 106 may be connected via one or more communication networks (not shown for clarity).

In various embodiments, server system 104 may be configured to provide services (e.g., software applications, email services, etc.) to various users, such as a user of user device 102. For example, in one embodiment, server system 104 may be an application server that may be remotely accessed by a user of user device 102. In the depicted embodiment, a user of user device 102 sends access request 110 to access a service provided by server system 104. As discussed above, server system 104 may limit access to the services it provides to only authorized users (e.g., to protect sensitive data, etc.).

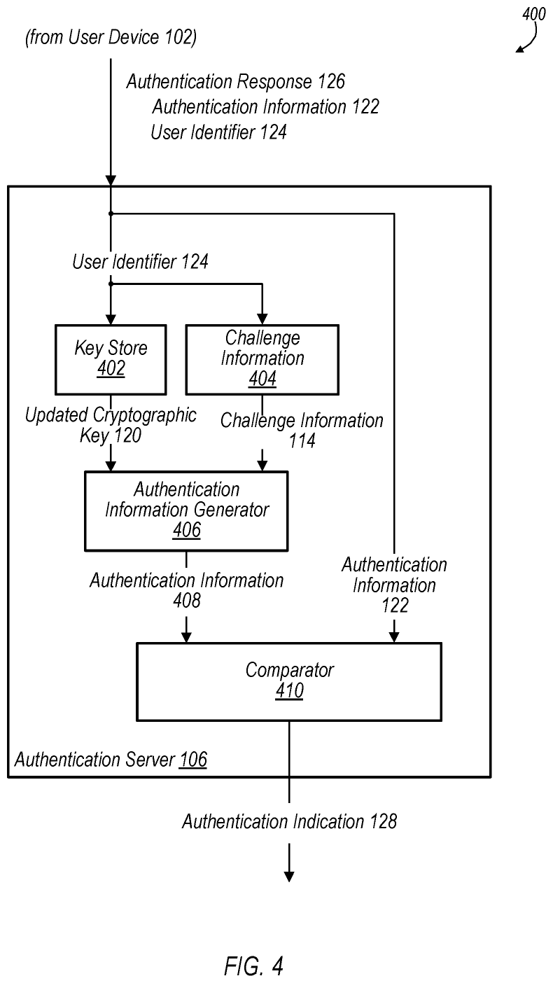

System 100 of FIG. 1 further includes authentication server 106. In various embodiments, server system 104 may delegate the process of authenticating the user of user device 102 to authentication server 106. For example, in the depicted embodiment, after receiving the access request 110, server system 104 sends an authentication request 112 to authentication server 106, requesting that authentication server 106 authenticate the user to the service provided by server system 104. In various embodiments, authentication server 106 is a computer system that is operable to perform authentication operations for various services provided by various server systems, such as server system 104. As will be discussed in more detail below with reference to FIG. 4, authentication server 106 may be configured to determine whether to authenticate the user of user device 102 based on authentication information provided by the user device 102. Authentication server 106 may then send an authentication indication 128 to server system 104 indicating whether the user of user device 102 is authenticated to the service provided by server system 104.

In various embodiments, after receiving authentication request 112, authentication server 106 may be configured to cause an authentication challenge 113, including challenge information 114 and seed identifier 115, to be sent to user device 102. As discussed in more detail below, challenge information 114 may be a random or pseudo-random numeric or alphanumeric value generated using any suitable algorithm or function. Note that challenge information 114 may be sent as part of either an “in-band” message (e.g., as part of an HTTP message) or “out-of-band” message (e.g., as part of an SMS message, MMS message, etc.) in various embodiments of the present disclosure.

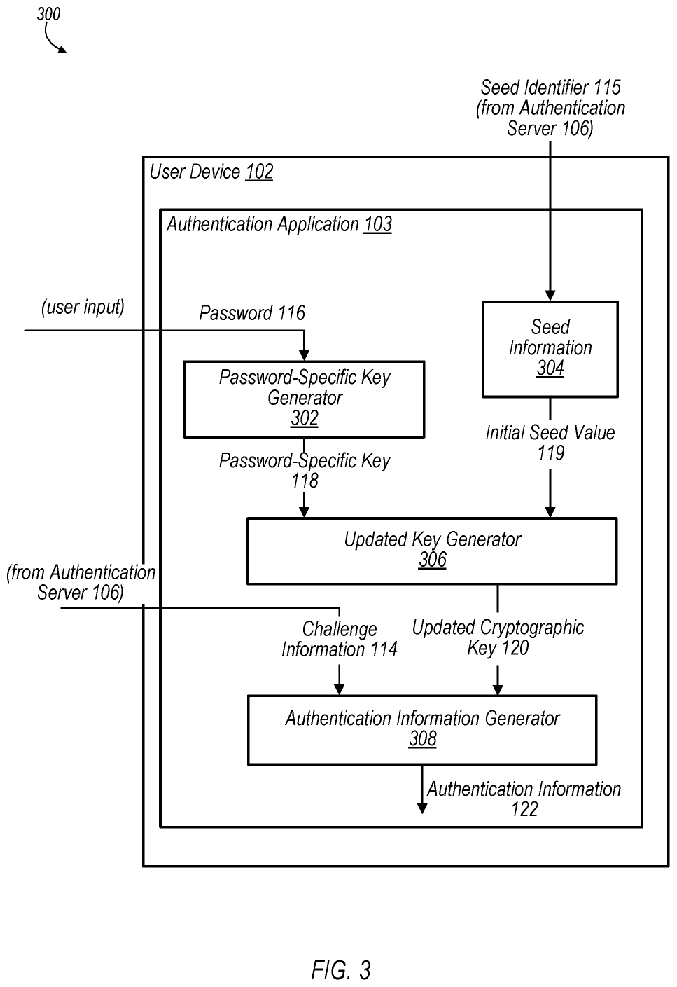

As shown in FIG. 1, user device 102 includes authentication application 103. In various embodiments, authentication application 103 is operable to use challenge information 114 to generate authentication information 122, which may be provided to authentication server 106 for validation. More specifically, in various embodiments, authentication application 103 is configured to generate authentication information 122 based on a password-specific cryptographic key, as discussed in more detail with reference to FIG. 3. For example, authentication application 103 may be operable to receive (e.g., via an input device, such as a touchscreen) a password 116 from a user of user device 102. Further, in various embodiments, authentication application 103 may be configured to generate a password-specific key 118 (e.g., using PBKDF2 or any other suitable key-derivation functions) based on the password 116.

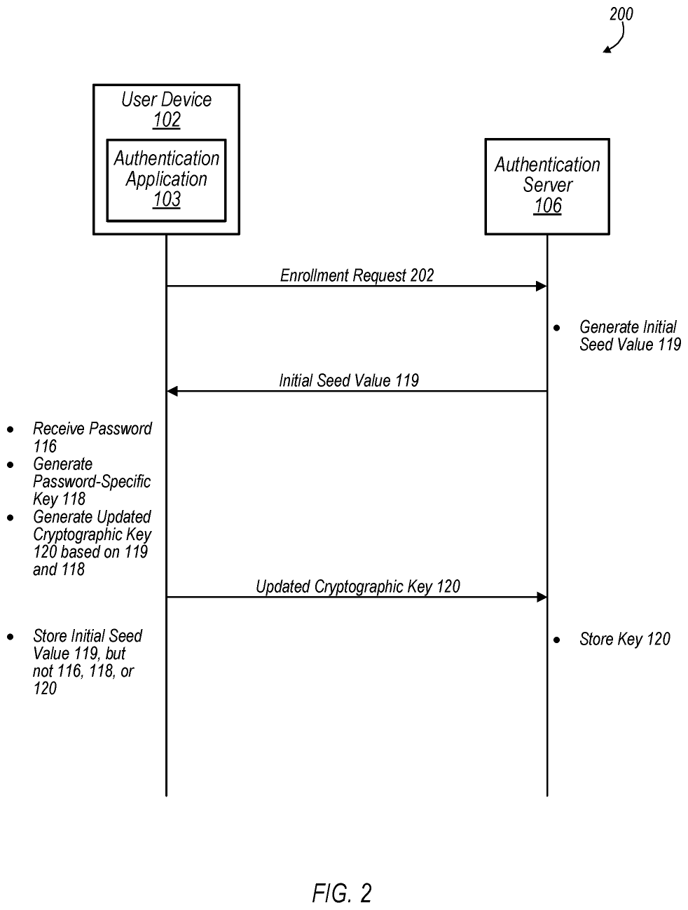

In various embodiments, authentication application 103 may have access to various seed values associated with various services, where the seed values are usable by the authentication application 103 to generate authentication information for the various services. In the depicted embodiment, authentication application 103 may use seed identifier 115 to retrieve a particular seed value—initial seed value 119, in the depicted embodiment—that corresponds to the service provided by server system 104. As discussed in more detail with reference to FIG. 2, initial seed value 119 is a value provided by authentication server 106 to user device 102 during an enrollment operation. In various embodiment, authentication application 103 is operable to generate an updated cryptographic key 120 based on password-specific key 118 and initial seed value 119. Having generated updated cryptographic key 120, authentication application 103 may then generate authentication information 122 based on updated cryptographic key 120 and challenge information 114. User device 102 may then send authentication response 126, including authentication information 122 and user identifier 124 (e.g., a username) to authentication server 106 for authentication. Note, however, that in various embodiments, user device 102 does not send the password 116 to the authentication server 106.

Authentication server 106, in various embodiments, is configured to determine whether to authenticate the user based on authentication information 122. For example, as discussed with reference to FIG. 4, authentication server 106 may store a copy of updated cryptographic key 120 (but not password 116) and use key 120 to generate authentication information that can be used to determine whether to authenticate the user to the service. Based on this determination, authentication server 106 may send an authentication indication 128 to server system 104, indicating whether the user is authenticated to the service. If the authentication indication 128 indicates that the user is authenticated, server system 104 may provide (or continue to provide) the service to the user of user device 102. If, however, the authentication indication 128 indicates that the user is not authenticated, server system 104 may be operable to take one or more corrective actions, such as denying the user access to the service and initiating further authentication operations.

The present disclosure addresses technical problems in the field of user authentication. More specifically, the disclosed systems and methods, in at least some embodiments, address security concerns associated with storing user credentials on, and transmitting those credentials between, a user device and a server system. As noted above, when stored on a server system, user credentials may be vulnerable to discovery by an unauthorized third party (e.g., in the event of a data breach). User credentials may be similarly vulnerable to discovery when stored on a user device. For example, in some instances, a user device may be compromised with malware capable of identifying sensitive authentication information (e.g., a password, etc.) and transmitting that information to an unauthorized user at a remote computer system. Further, user credentials may be susceptible to interception by an unauthorized third party during transit between the user device and the server system. Thus, in various instances, storing and transmitting user credentials, such as a user's password, may create various security concerns. In an alternative system that does not utilize the disclosed systems or methods, the unauthorized user may be able to obtain the user credentials and successfully pose as the authorized end user, accessing the service provided by server system 104.

Various embodiments of the present disclosure, however, improve user authentication by protecting the user credentials from discovery by unauthorized third parties while improving the security of the user authentication process. For example, in various embodiments, the user's credentials are not stored by or transmitted between any of the user device 102, the server system 104, or the authentication server 106, eliminating the risk that those credentials will be discovered through a data breach or while in transit. Instead, as discussed in more detail with reference to FIG. 4, authentication server 106 stores updated cryptographic key 120, a value generated based on a password-specific cryptographic key 118. Thus, even if authentication server 106 were compromised, an unauthorized third party would not obtain the user's actual credentials but rather the updated cryptographic key 120, a value that, by itself, would not enable the unauthorized third party to access the service provided by server 104 while posing as the authorized user.

As discussed in more detail below, in the event of a data breach, authentication server 106 and user device 102 may perform additional enrollment operations during which authentication server 106 may obtain a new updated cryptographic key 120 without requiring the user to establish a new password. Stated differently, the updated cryptographic key 120 that is generated during the enrollment process will be different each time the enrollment operations are performed (e.g., because updated cryptographic key 120 is based, in part, on initial seed value 119, which would vary), even if the underlying user credential (e.g., password) is the same. Accordingly, the updated cryptographic key 120 for a user for one service is not usable to generate valid authentication information for any other services or users, in at least some embodiments. Thus, in various embodiments, a user may safely use the same password across multiple different services (that use the disclosed systems and methods) without compromising the security of any of the other services in the event of a data breach.

Further, in various embodiments of the present disclosure, even if the user's password 116 were obtained by an unauthorized third party, this alone would not enable the third party to access the service posing as the user. Instead, since the updated cryptographic key 120 is generated in various embodiments by authentication application 103 based on both the initial seed value 119 and the password 116, an unauthorized third party would additionally need to obtain both values before being able to accurately reconstruct the updated cryptographic key 120. In short, the disclosed embodiments further improve data security, particularly in the context of user authentication.

Additionally, note that, although the user of user device 102 is being authenticated on the basis of authentication information 122, in various embodiments, the underlying authentication operations may not be exposed to the user. That is, in various embodiments, the user may simply authenticate herself by providing a credential (e.g., password 116), unaware that the disclosed authentication techniques are being implemented. Thus, various embodiments of the present disclosure preserve the simplicity to the user of providing a user credential, while the ultimate authentication determination is based on the more cryptographically secure authentication information that is generated based on a password-specific cryptographic key. Therefore, in various embodiments, the disclosed systems and methods improve user authentication by protecting the user credentials from discovery by unauthorized third parties while improving the security of the user authentication process, thereby improving the functioning of system 100 as a whole.

Turning now to FIG. 2, a communication diagram is depicted illustrating an example exchange 200 for enrollment operations between user device 102 and authentication server 106, according to some embodiments. More specifically, exchange 200 depicts a process in which the user of user device 102 enrolls in an authentication service provided by authentication server 106 (e.g., to authenticate the user to the service provided by server system 104). Note that, in various embodiments, the process depicted in exchange 200 may take place prior to the authentication operations described herein (e.g., prior to authentication server 106 sending the authentication challenge 113 to user device 102). Further, note that at no point in exchange 200 does the user device 102 transmit, or the authentication server 106 store, a password 116 provided by the user, according to various embodiments.

In the depicted embodiment, authentication application 103, executing on user device 102, sends an enrollment request 202 to authentication server 106. In various embodiments, enrollment request 202 is a request to enroll the user in an authentication service provided by authentication server 106. In various embodiments, enrollment request 202 may specify the service for which the authentication services are sought (e.g., an identifier of the service provided by server system 104) and a user identifier (e.g., username, customer identifier, email identifier, etc.) associated with that service.

After receiving the enrollment request 202, authentication server 106 may generate initial seed value 119 and send it to the user device 102. In various embodiments, initial seed value 119 may be a random or pseudo-random number generated using any suitable random or pseudo-random function or algorithm. In one embodiment, for example, initial seed value 119 is a 32 byte random number generated by authentication server 106. Note, however, that this embodiment is provided merely as an example and is not intended to limit the scope of the present disclosure.

Once authentication application 103 receives the initial seed value 119, authentication application 103 may prompt the user to provide a password 116. Password 116, in various embodiments, may be any suitable numeric or alphanumeric sequence. Alternatively, in some embodiments, password 116 may correspond to a biometric reading of the user (e.g., fingerprint, facial pattern, voice characteristics, etc.), and the user may provide password 116 via one or more input devices (e.g., fingerprint scanner, camera, microphone, etc.) included in, or accessible to, user device 102. In such embodiments, information corresponding to the biometric reading of the user may be used as the password 116.

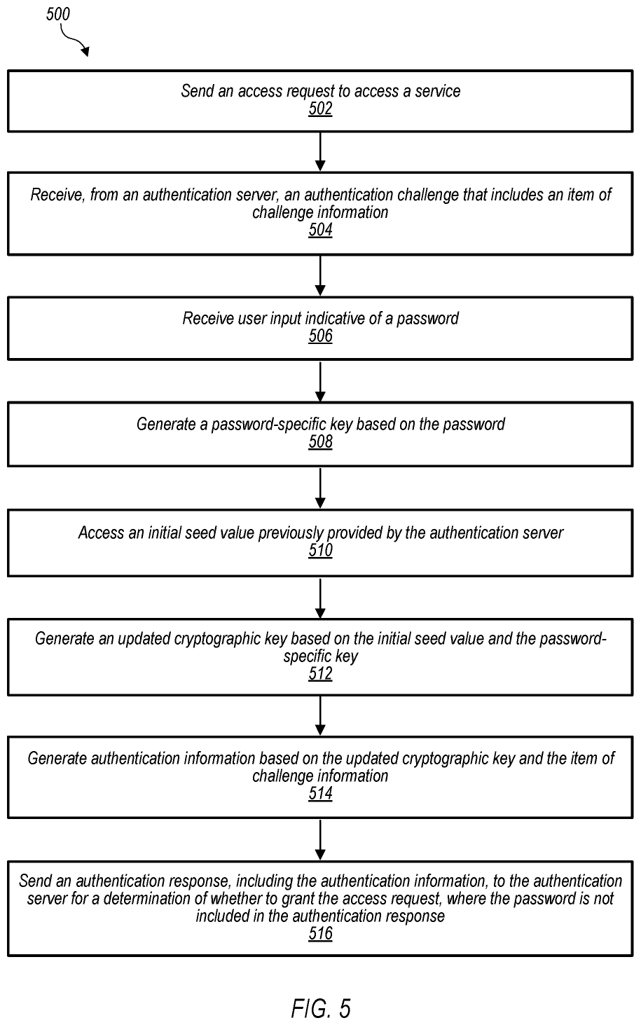

Having received password 116, authentication application 103 may, in various embodiments, generate password-specific key 118 and updated cryptographic key 120, as discussed in more detail below with reference to FIG. 3. Note that, in various embodiments, the process of generating password-specific key 118 and updated cryptographic key 120 may be the same or substantially the same in both the enrollment process, depicted in FIG. 2, and the authentication process, depicted in FIGS. 3 and 5.

In various embodiments, user device 102 may then transmit updated cryptographic key 120 to authentication server 106, which may store the key 120 in association with an identifier for the user (e.g., user identifier 124). Further, as shown in FIG. 2, user device 102 may store the initial seed value 119, but, in various embodiments, does not store any of password 116, password-specific key 118, or updated cryptographic key 120, further protecting these values from detection by unauthorized third parties.

As demonstrated by exchange 200, in various embodiment, the user's password 116 is not transmitted between, or persistently retained by, either of user device 102 or authentication server 106, even during the enrollment process. In various embodiments, after completing the exchange 200, authentication server 106 may be prepared to authenticate the user of device 102 using authentication information generated based on password-specific cryptographic keys. The description in the present disclosure of a computing device not “persistently retaining” information merits additional explanation. Consider the example of a user password that is entered into a computing device by the user. As is understood in the art, the password is said to not be persistently retained by the computing device if the computing device does not store (or takes steps to store) the data to nonvolatile memory. Thus, if the computing device stores a user password in volatile memory, the password is not considered to be persistently retained unless the computing device is configured to eventually write the data to nonvolatile memory (e.g., on a power-down or other triggering event). Accordingly, storing data to RAM without making provisions for an eventual write to persistent storage is not considered persistently storing or retaining data on a computing device for purposes of this disclosure.

As noted above, in various embodiments, the authentication server 106 and user device 102 may perform additional enrollment operations, such as those depicted in exchange 200, in response to a triggering event, such as a data breach or the expiration of a particular time period. For example, in some such embodiments, authentication server 106 may send to the user device 102 a new initial seed value, which may be different than the previous initial seed value 119. Further, user application 103 may again prompt the user to provide a password, which may be the same password as before or a new password. In various embodiments, authentication application 103 may use the password (whether new or previously used) to generate a password-specific key. Further, authentication application 103 may use the new initial seed value and the password-specific key to generate a new updated cryptographic key. Because it is based on a different initial seed value, the new updated cryptographic key will be a different value than updated cryptographic key 120, regardless of whether the user uses the same password or establishes a new password. Accordingly, as noted above, a user may safely use the same password across multiple services, according to various embodiments of the present disclosure, because for each service, the user will generate a distinct updated cryptographic key 120, which is used to generate the authentication information 122.

Referring now to FIG. 3, a block diagram illustrating an example embodiment of user device 102 and authentication application 103 is shown. In various embodiments, authentication application 103 is operable to generate authentication information 122 based on a password 116 provided by a user during the authentication process. That is, as described in more detail below, authentication application 103 is operable to generate an updated cryptographic key 120 based on an initial seed value 119 and a password-specific cryptographic key 118, in various embodiments. Authentication application 103 may then use that updated cryptographic key 120, along with challenge information 114, to generate the authentication information 122 to be sent to authentication server 106.

User device 102 may be any suitable computing device, such as a desktop computer, laptop computer, smartphone, etc. In various embodiments, when a user of device 102 attempts to access a service provided by server system 104, server system 104 may delegate the process of authenticating the user to authentication server 106. To this end, authentication server 106 may send an authentication challenge 113, including challenge information 114 and seed identifier 115, to user device 102.

To generate the authentication information 122, authentication application 103 may prompt the user to provide (e.g., via a touchscreen, keyboard, or any other suitable input device) user input indicative of a password 116, such as an alphanumeric string or PIN code. Note, however, that in some embodiments, rather than being a string or PIN code, password 116 may correspond to a biometric reading of the user (e.g., fingerprint, facial pattern, etc.), and the user may provide password 116 via one or more input devices (e.g., fingerprint scanner, camera, etc.) included in or accessible to user device 102. In such embodiments, information corresponding to the biometric reading of the user may be used as the password 116.

As shown in FIG. 3, authentication application 103 includes password-specific key generator 302, which, in various embodiments, is configured to generate a password-specific cryptographic key 118 based on password 116. Password-specific key generator 302 may use any suitable key-derivation function in generating password-specific cryptographic key 118. For example, in various embodiments, password-specific key generator 302 may use PBKDF2, SHA, Argon2, or any other suitable key-derivation function, including various hash-based algorithms, to generate password-specific cryptographic key 118.

FIG. 3 further includes seed information 304, which may include various seed values for use in user authentication with various services. In FIG. 3, authentication application 103 may use seed identifier 115 to identify and retrieve an initial seed value 119 that corresponds to the particular service provided by server system 104. Further, authentication application 103 includes updated key generator 306, which, in various embodiments, is operable to generate updated cryptographic key 120 based on an initial seed value 119 and password-specific cryptographic key 118. Updated key generator 306 may use any of various suitable cryptographic algorithms or techniques to generate updated cryptographic key 120. For example, in one embodiment, updated key generator 306 may perform a one-time pad using the password-specific key 118 and the initial seed value 119. In other embodiments, however, updated cryptographic key 120 may be generated by encrypting the initial seed value 119 using the password-specific key 118 (e.g., using AES, Triple DES, or any other suitable encryption algorithm). Note that these embodiments are provided merely as examples and one of ordinary skill in the art with the benefit of this disclosure will recognize that other techniques for generating updated cryptographic key 120 based on password-specific key 118 and initial seed value 119 may be utilized.

Authentication application 103 further includes authentication information generator 308. In various embodiments, authentication information generator 308 is configured to generate authentication information 122 based on the updated cryptographic key 120 and the challenge information 114. In various embodiments, challenge information 114 may be a random or pseudo-random value (e.g., an integer, floating point number, alphanumeric value, etc.) generated using any suitable algorithm or function. In some embodiments, for example, the pseudo-random function used to generate challenge information 114 may be seeded with a value corresponding to the time at which the challenge information 114 is generated. Authentication information generator 308 may use any one of various suitable cryptographic algorithms or techniques to generate authentication information 122. For example, in some embodiments, the authentication information 122 is a one-time passcode (OTP) that is usable by the authentication server 106 to authenticate the user. In such embodiments, authentication information generator 308 may generate the OTP based on the updated cryptographic key 120 and the challenge information 114 using any suitable OTP-generation algorithm, such as a time-based one-time passcode (TOTP) algorithm, a hash-based message authentication code (HMAC) OTP (HOTP) algorithm, etc. In other embodiments, however, authentication information generator 308 may generate authentication information 122 by encrypting the challenge information 114 based on the updated cryptographic key 120 (e.g., using AES, Triple DES, etc.). Note, however, that these embodiments are provided merely as examples and other techniques (such as OATH, EMV, etc.) may be implemented to generate authentication information 122, as desired.

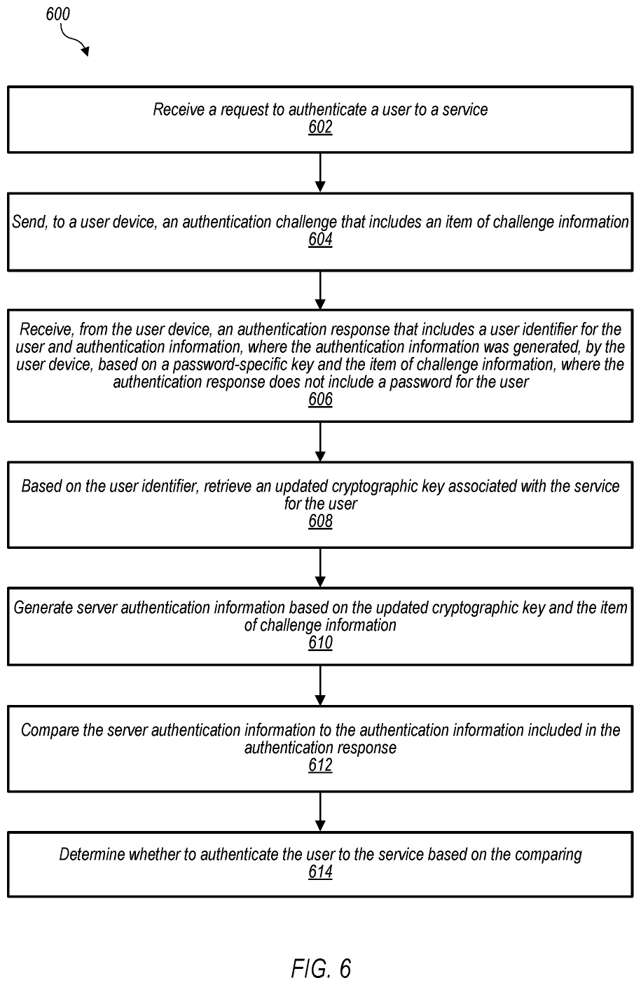

Once generated by authentication application 103, authentication information 122 may be output such that user device 102 may send it, along with a user identifier 124 in some embodiments, as part of an authentication response 126 to authentication server 106. As discussed in more detail below with reference to FIGS. 4 and 6, authentication server 106 may use the authentication information 122 to determine whether to authenticate the user to the service provided by server system 104.

Thus, in the embodiment depicted in FIG. 3, authentication application 103 is operable to generate an updated cryptographic key 120 based on a user-provided password 116. In various embodiments, neither the user-provided password 116 nor the password-specific cryptographic key 118 are persistently retained by the authentication application 103 or user device 102 after the authentication information 122 has been sent to the authentication server 106. Thus, even if user device 102 were compromised with malware (as discussed above), an unauthorized user would not be able to obtain the user's password 116. At most, in such embodiments, the unauthorized user would simply obtain the initial seed value 119, which, by itself, is not usable to generate valid authentication information 122. Further, as the password 116 is not transmitted to the authentication server 106, the disclosed systems and methods eliminate the risk that password 116 will be intercepted in transit. Thus, authentication application 103, in at least some embodiments, improves user authentication by protecting a user's credentials while providing secure authentication information.

Turning now to FIG. 4, a block diagram 400 illustrating an example authentication server 106 is depicted, according to some embodiments. In various embodiments, authentication server 106 may be operable to determine whether to authenticate a user to a service provided by server system 104 based on authentication information 122. Note that, although server system 104 and authentication server 106 are discussed separately herein, in various embodiments, server system 104 may be configured to perform some or all the functionality described with reference to authentication server 106.

In FIG. 4, authentication server system 108 receives authentication response 126, including authentication information 122 and user identifier 124, from user device 102. Authentication server 106 includes key store 402. As noted above, authentication server 106 may, in various embodiments, perform authentication operations for various services, each of which may have numerous authorized users. Accordingly, in such embodiments, authentication server 106 may store (e.g., in key store 402) keys associated with users of these various services.

As noted above with reference to FIG. 2, authentication server 106 may receive and store the updated cryptographic key 120, associated with the user for the particular service provided by server system 104, from user device 102 during an enrollment operation. In some embodiments, authentication server 106 may use user identifier 124 during authentication to retrieve updated cryptographic key 120. In the depicted embodiment, authentication server 106 further includes challenge information 404, which may include challenge information provided by authentication server 106 to various end users being authenticated. In FIG. 4, authentication server 106 may use the user identifier 124 to retrieve the challenge information 114 provided to the user device 102.

Authentication server 106 further includes authentication information generator 406, which, in various embodiments, is configured to generate authentication information 408 based on updated cryptographic key 120 and challenge information 114. As with authentication information generator 308 of FIG. 3, authentication information generator 406 of FIG. 4 may use any one of various suitable cryptographic algorithms or techniques to generate authentication information 408 (e.g., a TOTP algorithm, HOTP algorithm, etc.). Note, however, that in various embodiments, both authentication information generator 308 and authentication information generator 406 use the same cryptographic algorithms or techniques such that, given the same updated cryptographic key 120 and challenge information 114, both will produce the same authentication information value.

Authentication server 106 further includes comparator 410. In various embodiments, comparator 410 is operable to compare authentication information 408 with authentication information 122, received from user device 102, and generate authentication indication 128. In various embodiments, authentication indication 128 may be expressed as a Boolean value, numeric value, or in any other suitable format that specifies the outcome of the comparison performed by comparator 410. Authentication indication 128 may, in various embodiments, be provided to server system 104 and may indicate whether the user is authenticated to the service. For example, in response to authentication information 408 matching authentication information 122, authentication indication 128 may indicate that the user is authenticated to the service. If, however, authentication information 408 does not match authentication information 122, authentication indication 128 may indicate that the user is not authenticated to the service, and server system 104 or authentication server 106 may take one or more corrective actions, such as denying the user access to the service, initiating additional authentication operations, providing the user with a challenge question, etc.

Thus, in various embodiments, authentication server 106 may determine whether to authenticate the user of user device 102 based on the authentication information 122, which in turn is based on a user-provided password 116. Further, in various embodiments, since the password 116 is not directly used by the authentication server 106 during the authentication process, the password 116 is not sent to, or stored by, authentication server 106, providing various improvements to the security and functioning of the user authentication process, as discussed above.

### Example Methods

Referring now to FIG. 5, a flow diagram illustrating an example method 500 for generating authentication information using a password-specific cryptographic key is depicted, according to some embodiments. In various embodiments, method 500 may be performed, e.g., by authentication application 103 of FIG. 1, to authenticate a user of user device 102 to a service provided by server system 104. For example, user device 102 may include (or have access to) a non-transitory, computer-readable medium having program instructions stored thereon that are executable by the user device 102 to cause the operations described with reference to FIG. 5. In FIG. 5, method 500 includes elements 502-516. While these elements are shown in a particular order for ease of understanding, other orders may be used. In various embodiments, some of the method elements may be performed concurrently, in a different order than shown, or may be omitted. Additional method elements may also be performed as desired.

At 502, in the illustrated embodiment, a user device sends an access request to access a service. For example, in some embodiments, user device 102 may send access request 110 to server system 104, requesting access to a service provided by server system 104. At 504, in the illustrated embodiment, the user device receives, from an authentication server, an authentication challenge that includes an item of challenge information. For example, in some embodiments, user device 102 receives authentication challenge 113 that includes challenge information 114 and seed identifier 115 from authentication server 106.

At 506, in the illustrated embodiment, the user device receives user input indicative of a password. For example, authentication application 103 may prompt the user to provide a password 116 via an input device (e.g., a touchscreen). At 508, in the illustrated embodiment, the computing device generates a password-specific key based on the password. For example, in some embodiments, user device 102 may perform a cryptographic function (e.g., a key-derivation function) on the password 116 to generate a password-specific key 118.

At 510, in the illustrated embodiment, the user device accesses an initial seed value that was previously provided by the authentication server. For example, in some embodiments, authentication application 103 may use the seed identifier 115 to retrieve initial seed value 119 from seed information 304. At 512, in the illustrated embodiment, the user device generates an updated cryptographic key based on the initial seed value and the password-specific key. For example, in some embodiments, authentication application 103 includes an updated key generator 306 that is operable to generate updated cryptographic key 120 based on password-specific key 118 and initial seed value 119.

At 514, in the illustrated embodiment, the user device generates authentication information based on the updated cryptographic key and the item of challenge information. For example, in some embodiments, authentication application 103 includes authentication information generator 308 that is operable to generate authentication information 122 based on the challenge information 114 and the updated cryptographic key 120. In some embodiments, the authentication information may be an OTP that is usable by the authentication server to authenticate the user to the service. In some such embodiments, for example, generating the authentication information includes using the HMAC-based OTP algorithm to generate the OTP. In other embodiments, however, generating the authentication information includes encrypting the item of challenge information using the updated cryptographic key to generate the authentication information.

At 516, in the illustrated embodiment, the user device sends an authentication response, including the authentication information, to the authentication server for a determination of whether to grant the access request, where the password is not included in the authentication response. For example, in some embodiments, user device 102 sends the authentication response 126, including authentication information 122, to the authentication server 106 for validation.

Note that, in some embodiments, method 500 may further include various enrollment operations that are performed prior to receiving the authentication challenge from the authentication server (e.g., prior to element 504). For example, in some embodiments, prior to receiving the challenge information, the user device performs enrollment operations to enroll the user in an authentication service provided by the authentication server where, during the enrollment operations, the user device does not send the password to the authentication server. In some such embodiments, the enrollment operations include the user device receiving, from the authentication server, an initial seed value and generating the password-specific key based on the user-provided password. Further, in such embodiments, the enrollment operations may further include generating the updated cryptographic key based on the initial seed value and the password-specific key and sending the updated cryptographic key to the authentication server. Additionally, in some embodiments, the enrollment operations include the user device storing the initial seed value (e.g., initial seed value 119) sent by the authentication server, where the user device does not persistently retain the password, the password-specific key, or the updated cryptographic key after the enrollment operations.

Turning now to FIG. 6, a flow diagram illustrating an example method 600 for authenticating a user based on authentication information that was generated using a password-specific cryptographic key is depicted, according to some embodiments. In various embodiments, method 600 may be performed, e.g., by authentication server 106 of FIG. 1, to authenticate a user of user device 102 to a service provided by server system 104. For example, authentication server 106 may include (or have access to) a non-transitory, computer-readable medium having program instructions stored thereon that are executable by the authentication server 106 to cause the operations described with reference to FIG. 6. In FIG. 6, method 600 includes elements 602-614. While these elements are shown in a particular order for ease of understanding, other orders may be used. In various embodiments, some of the method elements may be performed concurrently, in a different order than shown, or may be omitted. Additional method elements may also be performed as desired.

At 602, in the illustrated embodiment, the authentication server receives a request to authenticate a user to a service. For example, in some embodiments, authentication server 106 may receive authentication request 112 from server system 104, requesting that the authentication server 106 authenticate a user of user device 102. At 604, in the illustrated embodiment, the authentication server sends, to a user device, an authentication challenge that includes an item of challenge information. For example, in some embodiments, authentication server 106 sends authentication challenge 113 that includes challenge information 114 and seed identifier 115 to user device 102.

At 606, in the illustrated embodiment, the authentication server receives, from the user device, an authentication response (e.g., authentication response 126) that includes a user identifier for the user (e.g., user identifier 124) and authentication information (e.g., authentication information 122), where the authentication information was generated, by the user device, based on a password-specific key (e.g., password-specific key 118) and an item of challenge information (e.g., challenge information 114). Further, in the illustrated embodiment, the authentication response does not include a password for the user.

At 608, in the illustrated embodiment, the authentication server retrieves, based on the user identifier, an updated cryptographic key associated with the service for the user. For example, in some embodiments, authentication server 106 may retrieve updated cryptographic key 120 from key store 402 using user identifier 124. At 610, in the illustrated embodiment, the authentication server generates server authentication information based on the updated cryptographic key and the item of challenge information. For example, in some embodiments, authentication server 106 may include authentication information generator 406 that is operable to generate authentication information 408 based on updated cryptographic key 120 and challenge information 114.

At 612, in the illustrated embodiment, the authentication server compares the server authentication information to the authentication information included in the authentication response. For example, in some embodiments, the authentication server 106 includes a comparator 410 that is operable to compare the authentication information 408 to the authentication information 122 to determine whether the two values compare equally. At 614, in the illustrated embodiment, the authentication server determines whether to authenticate the user to the service based on the comparing.

Note that, in some embodiments, method 600 may further include various enrollment operations that are performed prior to sending the authentication challenge to the user device (e.g., prior to element 604). For example, in some embodiments, prior to sending the authentication challenge, the authentication server performs enrollment operations to enroll the user in an authentication service provided by the authentication server where, during the enrollment operations, the authentication server does not receive the password of the user. In some such embodiments, the enrollment operations include the authentication server sending an initial seed value to the user device and receiving, from the user device, enrollment information that includes the updated cryptographic key, where the updated cryptographic key was generated by the computing device based on the initial seed value and the password-specific key.

Note that, in some embodiments, method 600 may include performing additional enrollment operations based on a triggering event, (e.g., detection of a data breach on authentication server 106, the passing of a particular time period since the enrollment operations were last performed, etc.). In some such embodiments, subsequent to a triggering event, method 600 may include the authentication server performing additional enrollment operations to obtain, from the user device, a subsequent updated cryptographic key, where the subsequent cryptographic key is generated based on a different initial seed value and a password of the user. In various embodiments, the password provided by the user during the additional enrollment operations may be the same as or different than the password previously selected by the user.

Further, in some embodiments, the authentication server is configured to authenticate the user to a plurality of services. For example, in some embodiments, authentication server 106 may perform authentication services for various services provided by various server systems (not shown in FIG. 1 for clarity). In such embodiments, method 600 may further include the authentication server performing enrollment operations for each of a plurality of the various services. For example, in some embodiments, the enrollment operations include the authentication server receiving, from the user device, a respective updated cryptographic key for each of the plurality of services, where each of the respective updated cryptographic keys is generated based on a different initial seed value. Further, in some such embodiments, each of the respective updated cryptographic keys is further generated based on the password for the user, where each of the respective updated cryptographic keys is a different value.

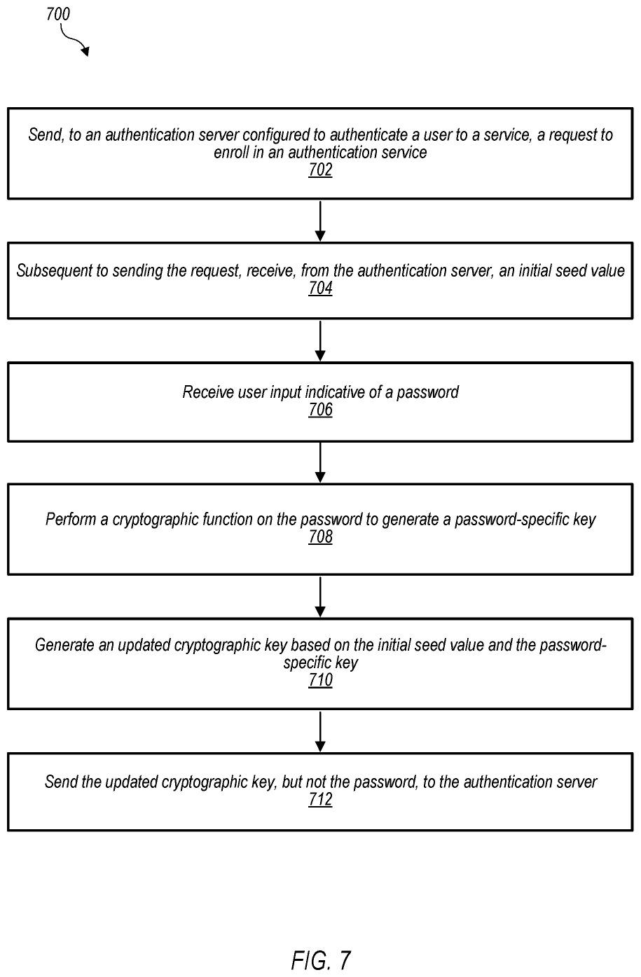

Referring now to FIG. 7, a flow diagram illustrating an example method 700 for enrolling a user of a user device in an authentication service provided by an authentication server is depicted, according to some embodiments. In various embodiments, method 700 may be performed, e.g., by user device 102 of FIG. 1. For example, user device 102 may include (or have access to) a non-transitory, computer-readable medium having program instructions stored thereon that are executable by the user device 102 to cause the operations described with reference to FIG. 7. In FIG. 7, method 700 includes elements 702-712. While these elements are shown in a particular order for ease of understanding, other orders may be used. In various embodiments, some of the method elements may be performed concurrently, in a different order than shown, or may be omitted. Additional method elements may also be performed as desired.

At 702, in the illustrated embodiment, the user device sends, to an authentication server configured to authenticate a user to a service, a request to enroll in an authentication service. In some embodiments, the request to enroll specifies a user identifier associated with the user for the service, where the request to enroll does not include a password of the user for the service. At 704, in the illustrated embodiment, the user device, subsequent to sending the request, receives, from the authentication server, an initial seed value (e.g., initial seed value 119). At 706, in the illustrated embodiment, the user device receives user input indicative of a password. For example, in some embodiments, authentication application 103 may prompt the user to provide a password via an input device.

At 706, in the illustrated embodiment, the user device performs a cryptographic function on the password (e.g., a key-derivation function) to generate a password-specific key (e.g., password-specific key 118). At 710, in the illustrated embodiment, the user device generates an updated cryptographic key (e.g., updated cryptographic key 120) based on the initial seed value and the password-specific key. In some embodiment, generating the updated cryptographic key includes encrypting the initial seed value based on the password-specific key using a symmetric-key encryption algorithm (e.g., AES, Triple DES, etc.). In other embodiments, however, generating the updated cryptographic key includes performing a one-time pad operation based on the initial seed value and the password-specific key.

At 712, in the illustrated embodiment, the user device sends the updated cryptographic key, but not the password, to the authentication server. Note that, in some embodiments, method 700 further includes the user device maintaining the password-specific key, the password, and the updated cryptographic key in a temporary storage of the user device until sending the updated cryptographic key to the authentication server, after which time these values are not persistently retained by the user device. Further note that, in some embodiments, the user of user device 102 may have a different password for the service provided by server system 104 and the authentication service provided by the authentication server 106.

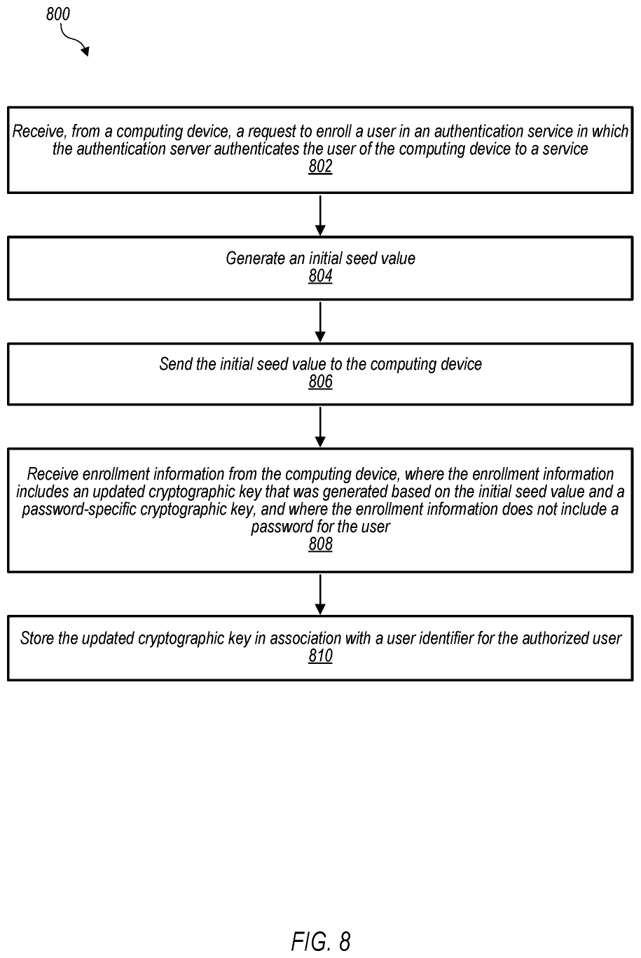

Turning now to FIG. 8, a flow diagram illustrating an example method 800 for enrolling a user of a user device in an authentication service provided by an authentication server is depicted, according to some embodiments. In various embodiments, method 800 may be performed, e.g., by authentication server 106 of FIG. 1. For example, authentication server 106 may include (or have access to) a non-transitory, computer-readable medium having program instructions stored thereon that are executable by the authentication server 106 to cause the operations described with reference to FIG. 8. In FIG. 8, method 800 includes elements 802-810. While these elements are shown in a particular order for ease of understanding, other orders may be used. In various embodiments, some of the method elements may be performed concurrently, in a different order than shown, or may be omitted. Additional method elements may also be performed as desired.

At 802, in the illustrated embodiment, the authentication server receives, from a user device, a request to enroll a user in an authentication service in which the authentication server authenticates the user to a service (e.g., a service provided by server system 104). At 804, in the illustrated embodiment, the authentication server generates an initial seed value and, at 806, it sends that initial seed value to the user device.

At 808, in the illustrated embodiment, the authentication server 106 receives enrollment information from the user device, where the enrollment information includes an updated cryptographic key that was generated, by the user device, based on the initial seed value and a password-specific cryptographic key, and where the enrollment information does not include a password for the user. At 810, in the illustrated embodiment, the authentication server stores the updated cryptographic key in association with a user identifier for the user.

### Example Computer System

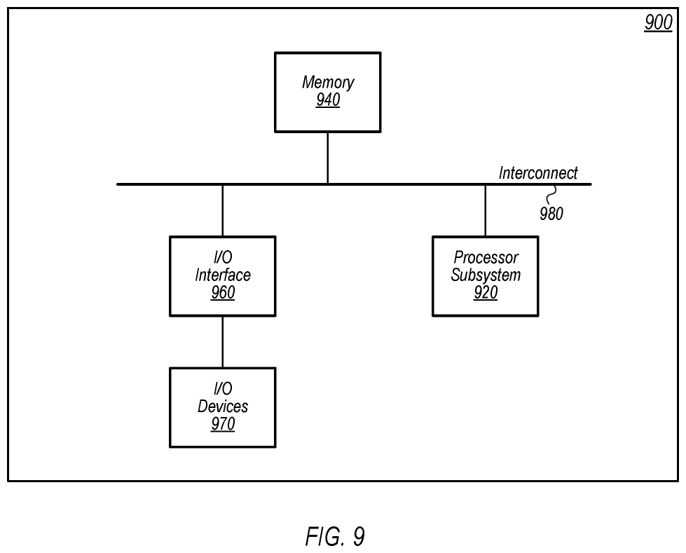

Referring now to FIG. 9, a block diagram of an example computer system 900 is depicted, which may implement one or more computer systems, such as user device 102 or authentication server 106 of FIG. 1, according to various embodiments. Computer system 900 includes a processor subsystem 920 that is coupled to a system memory 940 and I/O interfaces(s) 960 via an interconnect 980 (e.g., a system bus). I/O interface(s) 960 is coupled to one or more I/O devices 970. Computer system 900 may be any of various types of devices, including, but not limited to, a server system, personal computer system, desktop computer, laptop or notebook computer, mainframe computer system, server computer system operating in a datacenter facility, tablet computer, handheld computer, workstation, network computer, etc. Although a single computer system 900 is shown in FIG. 9 for convenience, computer system 900 may also be implemented as two or more computer systems operating together.

Processor subsystem 920 may include one or more processors or processing units. In various embodiments of computer system 900, multiple instances of processor subsystem 920 may be coupled to interconnect 980. In various embodiments, processor subsystem 920 (or each processor unit within 920) may contain a cache or other form of on-board memory.

System memory 940 is usable to store program instructions executable by processor subsystem 920 to cause system 900 perform various operations described herein. System memory 940 may be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 900 is not limited to primary storage such as system memory 940. Rather, computer system 900 may also include other forms of storage such as cache memory in processor subsystem 920 and secondary storage on I/O devices 970 (e.g., a hard drive, storage array, etc.). In some embodiments, these other forms of storage may also store program instructions executable by processor subsystem 920.

I/O interfaces 960 may be any of various types of interfaces configured to couple to and communicate with other devices, according to various embodiments. In one embodiment, I/O interface 960 is a bridge chip (e.g., Southbridge) from a front-side to one or more back-side buses. I/O interfaces 960 may be coupled to one or more I/O devices 970 via one or more corresponding buses or other interfaces. Examples of I/O devices 970 include storage devices (hard drive, optical drive, removable flash drive, storage array, SAN, or their associated controller), network interface devices (e.g., to a local or wide-area network), or other devices (e.g., graphics, user interface devices, etc.). In one embodiment, I/O devices 970 includes a network interface device (e.g., configured to communicate over WiFi, Bluetooth, Ethernet, etc.), and computer system 900 is coupled to a network via the network interface device.

Although the embodiments disclosed herein are susceptible to various modifications and alternative forms, specific embodiments are shown by way of example in the figures and are described herein in detail. It should be understood, however, that figures and detailed description thereto are not intended to limit the scope of the claims to the particular forms disclosed. Instead, this application is intended to cover all modifications, equivalents and alternatives falling within the spirit and scope of the disclosure of the present application as defined by the appended claims. The headings used herein are for organizational purposes only and are not meant to be used to limit the scope of the description.

This disclosure includes references to “one embodiment,” “a particular embodiment,” “some embodiments,” “various embodiments,” “an embodiment,” etc. The appearances of these or similar phrases do not necessarily refer to the same embodiment. Particular features, structures, or characteristics may be combined in any suitable manner consistent with this disclosure.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. When used in the claims, the term “or” is used as an inclusive or and not as an exclusive or. For example, the phrase “at least one of x, y, or z” means any one of x, y, and z, as well as any combination thereof (e.g., x and y, but not z).

It is to be understood that the present disclosure is not limited to particular devices or methods, which may, of course, vary. It is also to be understood that the terminology used herein is for the purpose of describing particular embodiments only and is not intended to be limiting. As used herein, the singular forms “a,” “an,” and “the” include singular and plural referents unless the context clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “memory device configured to store data” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

In this disclosure, various “modules” configured to perform designated functions are shown in the figures and described in detail above (e.g., password-specific key generator 302, updated key generator 306, authentication information generator 308, comparator 410, etc.). As used herein, the term “module” refers to circuitry configured to perform specified operations or to physical, non-transitory computer-readable media that stores information (e.g., program instructions) that instructs other circuitry (e.g., a processor) to perform specified operations. Such circuitry may be implemented in multiple ways, including as a hardwired circuit or as a memory having program instructions stored therein that are executable by one or more processors to perform the operations. The hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A non-transitory, computer-readable medium having instructions stored thereon that are executable by a computing device to perform operations comprising:
sending, by the computing device, an access request to access a service;
receiving, by the computing device from an authentication server configured to authenticate a user of the computing device to the service in response to the access request, an authentication challenge that includes an item of challenge information;
receiving, by the computing device, user input indicative of a password;
performing, by the computing device, a cryptographic function on the password to generate a password-specific key;
accessing, by the computing device, an initial seed value previously provided by the authentication server;
generating, by the computing device, an updated cryptographic key based on the initial seed value and the password-specific key;
generating, by the computing device, authentication information based on the updated cryptographic key and the item of challenge information; and
sending, by the computing device, an authentication response, including the authentication information, to the authentication server for a determination of whether to grant the access request, wherein the password is not included in the authentication response.

2. The non-transitory, computer-readable medium of claim 1, further comprising:
prior to receiving the authentication challenge, performing, by the computing device, enrollment operations to enroll the user in an authentication service provided by the authentication server, wherein, during the enrollment operations, the computing device does not send the password to the authentication server.

3. The non-transitory, computer-readable medium of claim 2, wherein the enrollment operations comprise:
receiving, by the computing device from the authentication server, the initial seed value;
generating, by the computing device, the password-specific key based on the password;
generating, by the computing device, the updated cryptographic key based on the initial seed value and the password-specific key; and
sending, by the computing device, the updated cryptographic key to the authentication server.

4. The non-transitory, computer-readable medium of claim 3, wherein the enrollment operations further comprise:
storing, by the computing device, the initial seed value sent by the authentication server, wherein the computing device does not persistently retain the password, the password-specific key, or the updated cryptographic key after the enrollment operations.

5. The non-transitory, computer-readable medium of claim 1, wherein the authentication information is a one-time passcode that is usable by the authentication server to authenticate the user to the service.

6. The non-transitory, computer-readable medium of claim 5, wherein the generating the authentication information includes using the HMAC-based one-time password algorithm to generate the one-time passcode.

7. The non-transitory, computer-readable medium of claim 1, wherein the generating the authentication information includes encrypting the item of challenge information using the updated cryptographic key to generate the authentication information.

8. A method, comprising:
receiving, by an authentication server, a request to authenticate a user to a service;
sending, by the authentication server to a computing device of the user, an authentication challenge that includes an item of challenge information;
receiving, by the authentication server from the computing device, an authentication response that includes a user identifier for the user and authentication information, wherein the authentication information was generated, by the computing device, based on a password-specific key and the item of challenge information, wherein the authentication response does not include a password for the user;
based on the user identifier, retrieving, by the authentication server, an updated cryptographic key associated with the service for the user;
generating, by the authentication server, server authentication information based on the updated cryptographic key and the item of challenge information;
comparing, by the authentication server, the server authentication information to the authentication information included in the authentication response; and
determining, by the authentication server, whether to authenticate the user to the service based on the comparing.

9. The method of claim 8, further comprising:
prior to sending the authentication challenge to the computing device, performing, by the authentication server, enrollment operations to enroll the user in an authentication service provided by the authentication server, wherein, during the enrollment operations, the authentication server does not receive the password.

10. The method of claim 9, wherein the enrollment operations comprise:
sending, by the authentication server, an initial seed value to the computing device; and
receiving, by the authentication server from the computing device, enrollment information that includes the updated cryptographic key, wherein the updated cryptographic key was generated, by the computing device, based on the initial seed value and the password-specific key.

11. The method of claim 8, wherein the authentication server is configured to authenticate the user to a plurality of services, the method further comprising:
performing, by the authentication server, enrollment operations for each of the plurality of services.

12. The method of claim 11, wherein the enrollment operations comprise:
receiving, from the computing device, a respective updated cryptographic key for each of the plurality of services, wherein each of the respective updated cryptographic keys is generated based on a different initial seed value.

13. The method of claim 12, wherein each of the respective updated cryptographic keys is further generated based on the password for the user, and wherein each of the respective updated cryptographic keys is a different value.

14. The method of claim 9, further comprising:
subsequent to a triggering event, performing, by the authentication server, additional enrollment operations to obtain, from the computing device, a subsequent updated cryptographic key, wherein the subsequent updated cryptographic key is generated based on a different initial seed value and the password of the user.

15. A non-transitory, computer-readable medium having instructions stored thereon that are executable by a computing device to perform operations comprising:
sending, by the computing device to an authentication server configured to authenticate a user of the computing device to a service, a request to enroll in an authentication service;
subsequent to sending the request to enroll, receiving, by the computing device from the authentication server, an initial seed value;
receiving, by the computing device, user input indicative of a password;
performing, by the computing device, a cryptographic function on the password to generate a password-specific key;
generating, by the computing device, an updated cryptographic key based on the initial seed value and the password-specific key; and
sending, by the computing device, the updated cryptographic key, but not the password, to the authentication server.

16. The non-transitory, computer-readable medium of claim 15, wherein the operations further comprise:
maintaining, by the computing device, the password, the password-specific key, and the updated cryptographic key in a temporary storage of the computing device until sending the updated cryptographic key to the authentication server.

17. The non-transitory, computer-readable medium of claim 15, wherein the generating the updated cryptographic key includes encrypting the initial seed value based on the password-specific key using a symmetric-key encryption algorithm.

18. The non-transitory, computer-readable medium of claim 15, wherein the generating the updated cryptographic key includes performing a one-time pad operation based on the initial seed value and the password-specific key.

19. The non-transitory, computer-readable medium of claim 15, wherein the request to enroll specifies a user identifier associated with the user for the service, wherein the request to enroll does not include a password of the user for the service.

20. The non-transitory, computer-readable medium of claim 19, wherein the password of the user for the service and the password are different.
